(19) United States
(12) Patent Application Publication
(10) Pub. No.: US 2001/0048595 A1
(43) Pub. Date: Dec. 6, 2001

(54) Methods and apparatus for illuminating an area

(76) Inventor: Richard J. Richardson, Simi Valley, CA (US)

Correspondence Address: HENRICKS SLAVIN AND HOLMES LLP, SUITE 200, 840 APOLLO STREET, EL SEGUNDO, CA, 90245

(21) Appl. No.: 09/783,935

(22) Filed: Feb. 14, 2001

Related U.S. Application Data
(63) Continuation-in-part of application No. 09/588,141, filed on Jun. 2, 2000.

(51) Int. Cl. F27D 21/02

(52) U.S. Cl. 362/92

(57) ABSTRACT

A light source for illuminating an area includes a cold cathode light source, and input and an output, and a converter coupled to the light source. The converter changes the current from an input alternating current supply to a lamp alternating current supply suitable for operating the lamp, for example from utility line voltage and current and changing it to an oscillating direct current supply. A display case such as a refrigeration unit may include an alternating current supply and a light source for illuminating an area within the display case. A current converter is coupled between the alternating current supply and the light source for changing the current from the supply at one voltage and frequency to a second voltage and a second frequency. In one preferred form, the light source is a cold cathode lamp at about 8500 Kelvin to include more blue light.

### CROSS REFERENCE TO RELATED APPLICATIONS

This is a continuation-in-part of co-pending application Ser. No. 09/588,141, filed Jun. 2, 2000.

### BACKGROUND OF THE INVENTIONS

1. Field of the Invention

The present inventions relate to light sources, for example light sources used to illuminate an area such as a display case, including cold cathode fluorescent lights and such lights that can be driven off of conventional line voltage with a minimum of intervening electronics.

2. Related Art

Conventional light sources are predominantly incandescent and fluorescent lamps. Incandescent lamps are inefficient, produce a substantial amount of heat and cast a yellowish light. Incandescent lamps have a relatively short lifetime. Fluorescent lamps are more efficient, produce a slightly different colored light and last longer than incandescent lamps. However, fluorescent lamps require ballasts and are sensitive to ambient temperature. Many conventional fluorescent lamps use special sockets or receptacles to accommodate dual pins at each end of the lamp, and the connection between the lamp and the socket may deteriorate over time and use.

When fluorescent lamps are used in extreme ambient conditions, such as in refrigerated display cases, the lamp may be driven at a higher current to produce the same output as at room temperature. Operation at higher currents reduces lamp life and may produce dis-colorations on parts of the lamp, such as near the cathode. Lamps also may flicker or strobe at lower temperatures, and it is more difficult to maintain the lamp wall at an optimum operating temperature.

Operating in extreme ambient conditions may also require special ballasts to produce the desired higher current. Such ballasts generally operate at higher frequencies and high open circuit voltages. These ballasts are expensive and may be subject to over heating and possibly complete failure. Many of the ballasts are also relatively bulky and often limit the size and available locations for which fluorescent lamps can be used.

Many different types of fluorescent lamp sockets may be prone to corrosion, arcing or other damage when subjected to the harsh operating conditions of refrigerated cases. For example, connected lamps and sockets may have water condensation or icing, which could lead to corrosion. During normal use or maintenance, fluorescent lamp sockets may be bumped or twisted out of alignment, reducing the quality of electrical connection between the lamp and the socket. Consequently, the socket may over heat or burn, the ballast may try to drive the lamp more or the electrical circuit may be broken entirely.

### SUMMARY OF THE INVENTIONS

Lighting assemblies and methods of providing light according to one or more aspects of the present inventions improve energy efficiency, and one or more aspects of these inventions reduces component costs and increases the average lifetime of the light source relative to conventional systems. One or more of these inventions can be used in a wide variety of applications, and can be easily retrofit to existing structures to more efficiently illuminate areas that are presently lighted with fluorescent lighting and possibly even incandescent lighting. One or more aspects of these inventions may also allow easier maintenance and replacement of lighting assemblies or parts, and may reduce service costs. Many other benefits are provided by these inventions, as will become more apparent with further discussion.

In accordance with one aspect of the present inventions, a lighting assembly in the form of a light source is provided having a cold cathode light source, cold cathode lamp or similar illumination element for illuminating an area. The lamp preferably includes an input and an output, where the input is coupled to a converter that is between an alternating current input and the lamp. The converter changes the current from the alternating current input to an alternating current supply suitable for operating the lamp, for example from utility line voltage and current and changing it to an oscillating direct current supply. In one preferred embodiment, the converter is as efficient as possible and converts the line voltage directly to the oscillating direct current with as few changes in the signal as possible. In another preferred embodiment, the lighting assembly can be configured to include a carrier and a lamp with its converter, for example for receiving line alternating current directly from a utility source, mounted to the carrier so that the assembly can be installed, removed and serviced as a unit or modular unit, if desired.

Using a cold cathode light source or similar lamp reduces energy consumption in many applications, and may further reduce energy use in other areas, such as air conditioning, due to reduced heat production in the lamp. Other overall costs may also be reduced, such as results from increased lamp life even as long as twice that of traditional lighting systems, elimination of some components such as lamp sockets and more expensive ballasts used on conventional fluorescent lamps and a reduction in and ease of maintenance. Cold cathode light sources are also typically smaller than conventional light sources having the same output, and some of the cold cathode lamps produce more blue light, giving the appearance of more natural light than with conventional fluorescent lamps. Additionally, some cold cathode lamps are more environmentally friendly and do not require special disposal. Because of their smaller size, the cold cathode lamps are more easily incorporated into assembled units for easier installation and maintenance. Furthermore, some applications may benefit from a significant reduction in wiring, for example using wiring as small as 26 gauge.

Cold cathode light sources can be used in a wide variety of illumination applications, including illuminating rooms or other open areas commonly used by people, pets and other animals, as well as in cabinets, cases and other furniture, including display cases. Lamps can be ceiling mounted, wall mounted, freestanding or otherwise supported or presented in many of the ways presently applicable to conventional lighting systems. The light sources can take any number of configurations depending on the manufacturing capabilities existing at the time. For example, many cold cathode lamps are produced in linear or curved form. Other detailed shapes may also be possible. In one particularly beneficial application of cold cathode light sources, cold cathode lamps can be used to illuminate product in display cases, especially where available space for product is to be maximized and where functional parts of the display cases are preferably designed to use as little space as possible.

In one preferred form of one aspect of the present inventions, a lighting system is provided with an input circuit having an AC input, for example line voltage and suitable current such as may be provided through typical building circuits from a standard utility connection for supplying 115 volts or 220 volts. The lighting system includes one or more cold cathode lamps, each lamp having an input or first contact for electrical connection for driving the lamp and an output or a second contact for electrical connection for driving the lamp. A converter is coupled between the input circuit and the first and second contacts of a given lamp for converting the AC input from ordinary line voltage to a voltage and current for operating the cold cathode lamp. The size, type and configuration of the cold cathode lamp used in the lighting system can be selected from a wide variety of lamps currently available. Lamps presently come in different sizes, shapes, lengths and color characteristics so suitable lamps can be selected for the desired application.

In one preferred form of one aspect of the inventions, the lighting system is installed as ceiling lighting, wall lighting or other environmental lighting for buildings, workspace, manufacturing areas, meeting areas as well as any other areas where hot cathode fluorescent lighting is presently used. For example, the lighting system can be used for ceiling lighting, and can be used to retrofit existing lighting fixtures as well as for new lighting fixtures. When used in conventional building spaces, the input circuit for the lighting system includes connectors for connecting to standard electrical wiring in the building. Additionally, when used to retrofit existing lighting fixtures and for installation as a new lighting fixture for conventional building designs, a housing may be provided to replace the housing of the existing lighting fixture to fill the ceiling space presently allocated for existing lighting fixtures. A light cover or diffuser, which may be identical to any existing light cover for hot cathode fluorescent light fixtures could cover the housing if desired. Preferably, the housing is formed from plastic or other suitable material having low electrical conductivity and low magnetic permeability, but it is possible that existing housings and diffusers can be used with only replacement of lamp sockets, wiring and electronics to accommodate the cold cathode lamps.

In one form of another aspect of the present inventions, the cold cathode lamps are mounted to and supported by a panel or other lamp support, which in turn is supported within the housing. The panel can be configured so as to position the lamps at any desired location or locations within the enclosure defined by the housing and the diffuser. For example, the panel can position all of the lamps close to the diffuser, close to the base of the housing and farther from the diffuser, or midway between the two. Alternatively, lamps can be placed differently within the same housing, for example one lamp close to the diffuser and another lamp further away. The panel is preferably formed from a plastic or other non-electrically conductive material, and also has a surface facing the lamps that is at least moderately reflective so that little or no light passes from the lamps to the opposite side of the panel. The lamp-facing surface is preferably white so as to diffusely reflect as much of the light as possible from the lamps while minimizing the amount of bright line reflection visible. In one form of the invention, the surface of the panel facing the lamps is uneven, to help in reducing the amount of bright line glare that might be visible from a reflection on the panel.

In another form of another aspect of the present inventions, lamps are mounted to a panel within an enclosure defined by the housing and the diffuser by lamp receptacles or sockets for supplying energy to lamps and for supporting the lamps on the panel. The receptacles in one form of the inventions take the form of monuments extending from the surface of the panel to space the lamps the desired distance from the panel. For a given lamp, a first receptacle may be provided with a side access only while a second receptacle may be provided with top access. The first receptacle would reduce the possibility of a person touching the conductive end of the lamp during operation or the contacts within the receptacle while the lamp is removed.

In another preferred form of one aspect of the present inventions, cold cathode lamps are mounted within a housing. The lamps may be mounted in any location and orientation. Adjacent lamps may be aligned or staggered laterally or transversely with respect to each other so that the ends of adjacent lamps may overlap longitudinally. A staggered distribution of lamps reduces the possibility of shadow. The amount of overlap can vary from a negative value representing a gap between adjacent lamps to as much as 100 percent, representing a doubling up of lamps. Additionally, different sized lamps, in terms of both length and diameter, can be used to appropriately configure the illumination of the desired area.

In a preferred embodiment, each light source is provided with a lens or a reflector or both configured in such a way as to preferably selectively improve or otherwise change the illumination of the product or the desired distribution of light within the case or other area relative to the bare lamp. In one preferred form of one aspect of the present inventions, the lens may be formed integral with a surrounding, preferably cylindrical, tubular cover around the lamp with a channel longitudinally through the cover formed eccentrically or off center to provide the desired optic effect. The tubular cover around the lamp helps to protect the lamp from impact and to insulate the lamp from the effects of the lower temperature in a refrigerated case. Additionally, the means used to change the light distribution may be formed as part of an assembly that is a unit or module. Such a unit may improve how easily the lighting assembly is installed and serviced, for example.

In another form of one aspect of the present inventions, the reflector is preferably formed flat and the lamp placed as close as possible to the reflector so as to maximize the desired distribution of light. For example, the lamp could be positioned as little as 1/4 inch or less from the reflector using appropriate mounting elements. In other forms, a reflective surface may be formed with shapes defined to distribute light in a way desired by the designer. By changing the distribution, the illumination of the area may become more uniform by reducing bright spots closer to the lamp, for example.

In another form of one aspect of the inventions, a lamp may be placed adjacent an unpolished or other surface less shiny than a polished mirror, but preferably still sufficiently reflective to otherwise improve the illumination back in the direction of the lamp. For example, smaller diameter lamps may produce sharper illumination lines such as reflections and transition lines between areas of full light and reduced light, and a surface less reflective than a polished mirrored surface may be preferred to soften the light reflected to certain areas.

In another preferred form of one aspect of the present inventions, the light source is easy to couple to an energy source. Preferably, the lamp includes leads or connectors that allow the lamp to be easily connected to an energy source. For example, contacts of the lamp can be inserted into respective cradles or other receptacles by simple interference fit or an over-center engagement. This may allow the lamp to be easily inserted and removed. Alternatively, the lamp may include connectors on conductors leading from the lamp that allow the lamp to be easily connected to and disconnected from the energy source. In another alternative, the lamp may be part of a module or lamp assembly having a conductive connector whereby the module can be mounted to a support surface having a mating connector so that mounting of the module to the support surface also makes the electrical connection sufficient to allow energizing the lamp. Then, the installation and servicing of the light assembly is easier and less time consuming. In a further embodiment, the lamp assembly may include a physical mounting assembly separate from the electrical connection, so that mounting the assembly is carried out separately from creating the electrical connection between the lamp and the energy source.

In another preferred form of one aspect of the present inventions, the light source may be part of a lighting assembly that itself is easy to couple to an energy source, for example as a unit. Preferably, the lighting assembly includes leads or connectors that allow the assembly to be easily connected to an energy source, such as through a simple connector or plug. This may allow the lighting assembly to be easily installed and removed, either in the first assembly steps or for servicing and replacement. The unit or assembly may include one or more lamps, their connectors to converters, for example, a support surface and means such as a connector for coupling one or more converters to a power source. The lamp may, but need not, include a protective tube or lens, that may be sealed with silicone or other sealing elements.

Mounting elements for the lamp may also take the form of clips or standoffs either permanently or removably engaging the lamp. Engagement between a lamp and clip can be accomplished through an interference fit or other engagement suitable to the application.

These and other aspects of the present inventions will be more fully understood in view of the drawings, a brief description of which follows, and the detailed description of the preferred embodiments.

### BRIEF DESCRIPTION OF THE DRAWINGS

FIG. 1 is a front elevation view of an area to be illuminated in accordance with one aspect of the present inventions, such as a refrigerated display case containing product for display.

FIG. 2 is a top plan and partial cutaway view of a refrigerated display case showing doors, shelves and light sources in accordance with one aspect of the present inventions.

FIG. 3 is a vertical side section of the refrigerated display case of FIG. 1 showing different configurations and combinations of light sources for the display case of FIG. 1.

FIG. 4 is a top plan and partial cutaway view of a lighting arrangement in accordance with one aspect of the present inventions.

FIG. 5 is a side view and partial cutaway of part of a lighting assembly in accordance with another aspect of the present inventions.

FIG. 6 is a side elevation view of a lamp mounting element in accordance with another aspect of the present inventions.

FIG. 7 is a partial longitudinal cross-section of an end of a lamp assembly of FIGS. 4 and 5 in accordance with one aspect of one of the present inventions.

FIG. 8 is a plan view of a light assembly in accordance with a further aspect of one of the present inventions.

FIG. 9 is a partial longitudinal cross-section of an end of a lamp assembly in accordance with another aspect of one of the present inventions.

FIG. 10 is a detailed view of one end of a lamp assembly and contact of FIG. 8.

FIG. 11 is an elevation view of the lamp assembly and contact of FIG. 10.

FIG. 12 is a longitudinal cross-section through part of a light assembly and mullion taken along line 12-12 of FIG. 8.

FIG. 13 is a longitudinal cross-section view of an end of a lamp assembly in accordance with a further aspect of one of the present inventions.

FIGS. 14 and 14A are transverse cross-sectional views of a light assembly and mullion.

FIG. 15 is a detail and partial cutaway view of a connector of the assembly of FIG. 14.

FIG. 16 is a front elevation view of a frame and mullion assembly showing an exemplary wiring arrangement.

FIG. 17 is a detail of a side elevation and partial cutaway view of a shelf assembly of the case of FIG. 3.

FIG. 18 is an exploded side elevation and partial section view of a lighting system in accordance with a further aspect of one of the present inventions such as may be used in buildings for room lighting, and the like.

FIG. 19 is a bottom plan view of a plurality of lamp assemblies mounted to a support panel for use in the lighting system of FIG. 18.

FIG. 20 is a schematic of an electrical circuit for use in driving the lamps in the lighting system of FIG. 18.

FIG. 21 is an isometric view of a lamp receptacle for use with the lamps in the lighting system of FIG. 18.

FIG. 22 is a vertical cross-section of the lamp receptacle of FIG. 21.

FIG. 23 is a top plan view of an open top for the lamp receptacle of FIG. 21.

FIG. 24 is a top plan view of a closed top for the lamp receptacle of FIG. 21.

### DETAILED DESCRIPTION OF THE PREFERRED EMBODIMENTS

The following specification taken in conjunction with the drawings sets forth the preferred embodiments of the present inventions in such a manner that any person skilled in the art can make and use the inventions. The embodiments of the inventions disclosed herein are the best modes contemplated by the inventor for carrying out the inventions in a commercial environment, although it should be understood that various modifications can be accomplished within the parameters of the present inventions.

The lighting assemblies and methods described herein for providing light can be used in a number of applications for illuminating an area, or area lighting, including for providing ambient light, and for illuminating product or items in a display case or in a cabinet, for example. One or more aspects of these inventions provide assemblies and methods for producing light that are more energy efficient and result in reduced component costs and in products with a longer useful life. Several of these inventions are particularly suited to operating in extreme conditions such as in refrigerated display cases, and they perform in many respects better than conventional lighting systems even under those extreme conditions.

These assemblies and methods will be described in the context of an example of a specific application, and the extension to other applications will be understood from the context of the examples. In one example, which is subject to relatively extreme environmental conditions, the lighting assemblies and methods are considered in the context of a refrigerated display case, one type of which operates at approximately 38 degrees Farenheit and another of which operates below 0 degrees Farenheit. Under these conditions, the conventional lighting system of a ballast, wiring, fluorescent lamp and sockets is particularly sensitive to temperature, moisture conditions and the quality of the electrical connections between the ballast and the lamp. However, the apparatus and methods of the present inventions reduce the effects that temperature and humidity have on the lighting system. Moreover, these apparatus and methods have a lower overall cost, provide significant energy savings, and provide better illumination of the product being displayed as well as the display case generally.

In one application of the present methods and apparatus, the lighting is used in stores and in display cases where food products and other consumables are displayed to consumers and other purchasers on shelf displays. A display case may take any number of different configurations. For example, the display case may be portable or fixed to a store floor or wall section. The display case may have one type of lighting system or several types. For the present discussion, the description of the display case and lighting configurations will be given in the context of refrigerated display cases, such as those found in grocery stores, convenience stores and the like. However, it should be understood that the invention is not limited to refrigerated display cases, food or other consumable products, but can be extended and is applicable to other lighting systems, for not only display cases but also other area lighting applications.

Where the refrigerated display case is a cooler, the normal operating temperature is about 38 degrees Farenheit. Where the case is a freezer, temperatures may be below zero degrees Farenheit. In either case, the relatively low temperatures have a significant impact on lighting systems used in the cases. With fluorescent lighting systems, the lower temperatures reduce the lamp wall temperature thereby decreasing the amount of light produced by the lamp. The lower temperatures may also produce strobing or flickering in the lamp. In order to bring the lamp output up to the desired level, the ballasts are operated with a higher current output to overdrive the lamp, which also has the effect of reducing lamp life. Over driving the lamp may also lead to ballast over heating or ballast failure.

Lower case temperatures may also lead to moisture condensation or icing on electrical components such as the lamp sockets, which may then lead to corrosion of such metal surfaces as the lamp and socket contacts. Corrosion can lead to inadequate electrical contact between the lamp and the socket, which in turn may over work the ballast as it tries to make up for the impaired lamp contact. Over time, the ballast may over heat and may fail due to the combination of over driving the lamp and the extra work that may be done to overcome the impaired electrical connection. One or more of these effects are reduced or eliminated when one or more aspects of the present inventions are used.

In accordance with one aspect of the present inventions, a lighting system or assembly of one embodiment of the inventions can be used in a display case, such as a refrigerated display case 20 (FIG. 1). The display case may be for a cooler or a freezer, for example, and includes doors 22 mounted in a surrounding frame 24. The doors 22 have glass panels 26, which allow someone, such as a customer in a supermarket, to look through the panels 26 at items 28 displayed on shelves 30 inside the case 20. The items 28 inside the display case 20 may or may not be refrigerated items, such as frozen foods. Typical refrigerated display cases, for example, use shelves that are assembled in units approximately 30 inches in length, across the front of the unit. Other details about conventional refrigerated display cases are included in U.S. Pat. No. 5,895,111, the specification and drawings of which are incorporated herein by reference.

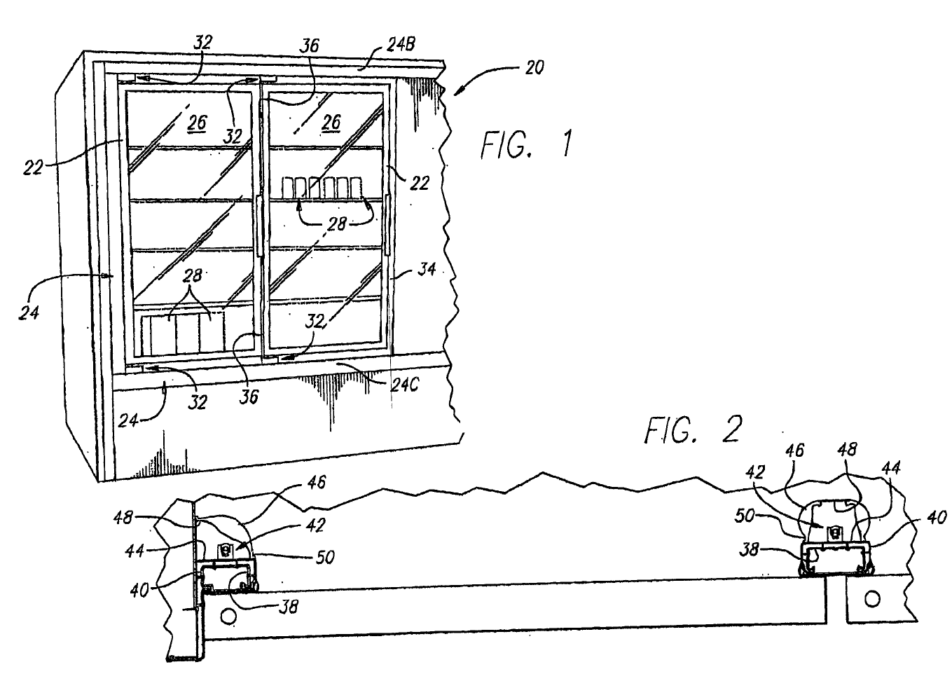

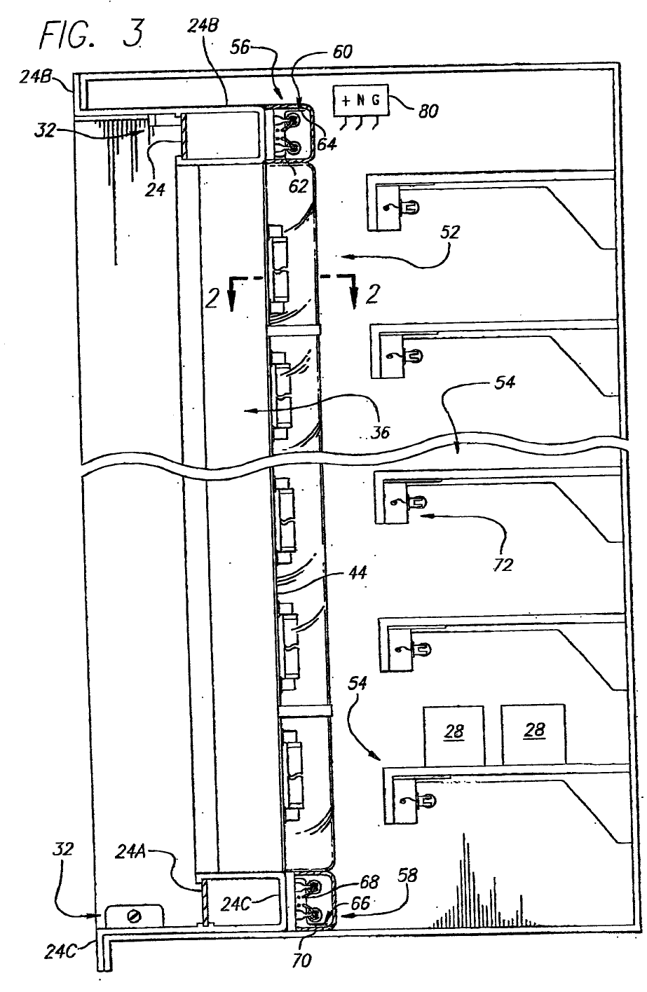

The doors 22 can be swing doors supported on hinges 32 (FIG. 2) or sliding doors (not shown). Most refrigerated display cases having multiple shelves for holding and displaying product are closed with doors, but some display cases are open units using a moving sheet of cold air over the front of case to keep the product refrigerated. The doors close and create a thermal and airtight seal against contact plates 24A in the frame 24 (FIG. 3) using gaskets (not shown). Along the tops and bottoms of the doors, the doors seal against upper and lower horizontal frame members, 24B and 24C, respectively, and along the sides, the doors seal against a side frame member 34 or a mullion 36 (FIG. 2). Each mullion 36 extends vertically between the top 24B and bottom 24C frame members, and is typically considered a frame element, supporting the structure and providing sealing surfaces for the sides of the doors. Conventional mullions typically house wiring for supplying electricity to various electrical components such as heater wires and lighting systems, as well as ballasts for energizing fluorescent light sources. This wiring and the ballasts take up considerable space in the mullion, and produce relatively complicated wiring schemes to supply the electrical energy to the fluorescent lamps.

In one example of a mullion for use with the present inventions, the mullion is an extruded aluminum structure 38 mounted at the top and bottom by suitable brackets (not shown) and covered by a plastic mullion cover 40. The mullion cover 40 supports a light source 42, described more fully below, for illuminating the items to be displayed (28 in FIG. 1) and preferably a reflector 44 for reflecting light from the light source 42 back into the case. The reflector can take any number of forms, from a polished mirror-like surface to a foil-type surface or an enamel or painted surface that is more reflective than absorptive of light. The actual light reflective characteristics of the surface will depend on the surface preparation and may be determined during the design process. It is intended that the term “reflector” include any light reflective surface.

The mullion cover also preferably supports one or more lenses 46 for distributing the light as desired. Multiple lenses may be coupled by a bridge 48 and retained in place on the mullion cover by one or more retaining clips 50. The bridge may be painted or formed with a matte white color to improve light distribution. Mirrored surfaces may also be included. The lenses 46 preferably have the optical characteristics set forth in the '111 patent. However, it should be understood that the lenses, when used, can take any number of configurations, generally with the goal of improving the illumination of product on the shelves or other product support in the display case.

In the preferred embodiment, the lighting system includes the light source or light sources 42, primarily, as well as any reflector and/or lenses that may be included. Preferably, the lighting system is designed to make the illumination of the product as clear and bright as possible without producing glare or excessive brightness. The lighting system also preferably produces a uniform illumination of the product across the front of the shelf, at all levels, and preferably at all depths from the front of the shelf to the back of shelf. However, because light intensity diminishes with the square of the distance from the light source, uniform illumination from the front of the shelf to the back of the shelf is more difficult to achieve.

The light sources 42 can be positioned and oriented in the display case in any number of ways. As shown in FIG. 3, the light source can be a vertical assembly 52 mounted on the mullion 36 to direct light theoretically in an approximate hemisphere extending rearwardly into the case toward the shelves 54 and the back of the display case. The hemisphere of distribution of the light is limited toward the front of the case by the reflector 44, and limited by the upper and lower ends of the light source(s) that may block light in the axial direction, as well as any opaque structures in the path of light. Where the vertical light assembly 52 is mounted on an end mullion at either side of the case, the reflector 44 is preferably a right angle or other shaped reflector to reflect light toward product being displayed, such as in the direction of the rear of the case and the opposite side. Alternatively, the angled surface, or the side of the case if the reflector is not extended out from the base of the light assembly, may be painted or otherwise coated with a suitable coating that can reflect all or a significant portion of the light produced by the lamp toward the frame or case wall. Coatings may be useful and sometimes more cost effective alternatives to forming structural materials into the desired shape and preparing the surface to have the desired characteristics.

The light sources can also be oriented as horizontal light assemblies such as the upper horizontal light assembly 56 and the lower horizontal light assembly 58. The upper horizontal light assembly 56 can be positioned in the case in any number of places for distributing light, but in a typical reach in display case, the upper horizontal light assembly 56 can be effectively placed adjacent a rear portion of the upper frame member 24B to illuminate product in the upper portions of the display case. The light assembly 56 can be mounted to the back of the upper frame element 24B by fasteners, adhesives or the like. In a preferred embodiment, the light assembly 56 extends the entire usable width of the display case and is positioned or configured in such a way that the desired amount of light is directed, preferably unobstructed, toward the desired area, such as onto product at the front of the case. Preferably, the light assembly 56 would include a substantially right angle reflector 60 extending the length of the light source with a base portion 62 extending vertically relative to the case and a side portion 64 extending substantially horizontally. Alternatively, as with the end mullion light assembly, the upper portion of the reflector and/or the upper portion of the case may be coated with a reflective or other desirable coating to achieve the intended redistribution of light coming from the light assembly to the upper portion of the case.

The lower horizontal light assembly 58 can be positioned in the case also in any number of places for distributing light, but it can be effectively placed adjacent to a rear portion of the lower frame member 24C to illuminate product in the lower portions of the display case. The light assembly 58 can be mounted to the back of the lower frame element 24C by fasteners, adhesives or the like. In a preferred embodiment, the light assembly 58 extends the entire usable width of the display case. Preferably, light assembly 58 would include a substantially right angle reflector 66 extending the length of the light source with a base portion 68 extending vertically relative to the case and a side portion 70 extending substantially horizontally. Each of the upper and lower light assemblies can be dimensioned, positioned and oriented in any number of ways to achieve the desired illumination given the surrounding structures and the area to be illuminated. Additionally, both the horizontal and the vertical light assemblies can be tilted, slanted or otherwise placed at an angle relative to the front, back, horizontal or the vertical to achieve the desired result. Alternatively, as with the end mullion and the upper horizontal light assemblies, the lower portion of the reflector and/or the lower portion of the case may be coated with a reflective or other desirable coating to achieve the intended redistribution of light coming from the light assembly to the upper portion of the case.

Light assemblies can also be mounted to or supported by other structures on or in the display case. For example, a light assembly 72 can be mounted horizontally on a shelf 54, for example to the bottom of the shelf, to illuminate product such as product 28 positioned below the light assembly 72. Light assembly 72 preferably extends horizontally the width of the shelf 54 to which it is attached, but the size of the light assembly 72 may be determined also by the size, position and orientation of product on the shelf below. Likewise, the position of light assembly 72 on the underside of the shelf 54 may be determined in part by the size, position and orientation of the product. Each light assembly may include a base reflector 72A as well as a side or other offset reflector 72B for redistributing light not shining directly at the shelves or product on the shelves. The reflectors may take any configuration of the reflectors described herein, and the side reflectors may take the form of painted surfaces on the undersides of the shelves, for example. The light assemblies may also be constructed or configured to redistribute light originally directed to undesirable areas of the case, such as the frame and the bottom surfaces of the shelf, and in the desired direction, such as toward product. The shelf assembly or variations on the shelf assembly can also be used in an open case or in other display applications, and the light assemblies can also be used in other applications, as well.

Illumination in the display case can be carried out by one or more combinations of light assemblies in the positions and orientations described, as well as in other forms, positions and orientations. Illumination in the display case is not limited to any particular one type of light assembly.

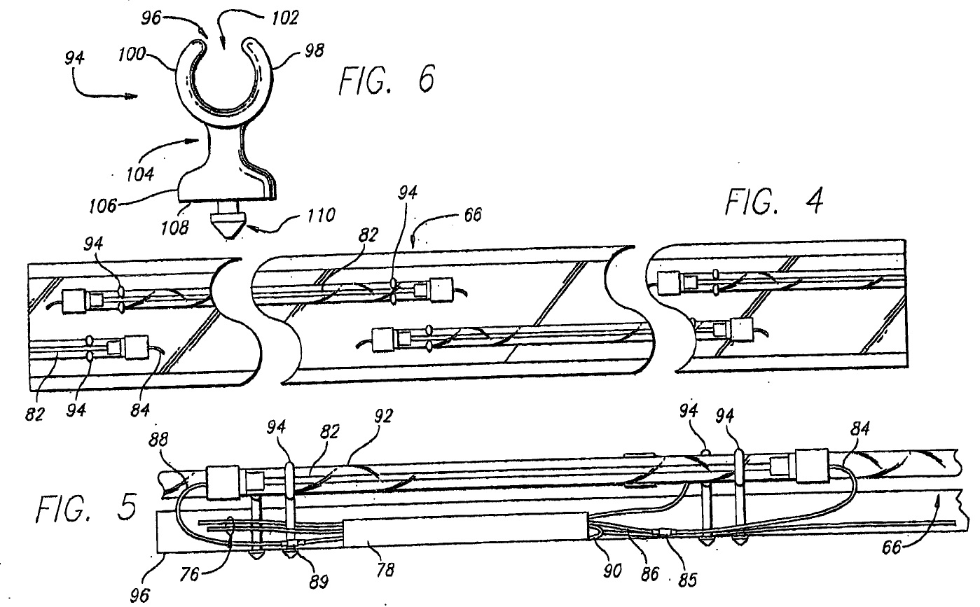

In the preferred embodiments, each lighting assembly is preferably easily installed and replaceable and easily coupled to an energy source. Each lighting assembly also preferably has a high light output with low energy consumption and can be selected from lamps having a number of different color characteristics. Structurally, the light assemblies are preferably smaller than conventional lighting systems producing the same amount of light with the same efficiency, and can come in sufficiently different lengths and/ors shapes to allow flexibility in positioning and orienting the light assemblies. The light assemblies are also preferably capable of operating at a variety of different temperatures without significantly affecting the functioning of the light assemblies. In one embodiment of a light assembly in accordance with several aspects of the present inventions, the light assembly 74 (FIGS. 4-6) includes an alternating current input 76 and a converter 78, such as the Visualux inverter Model No. VLXINV4202U for 301 to 420 mm lamps, made by Visualux of Ilfracombe, England, for changing the current from the alternating current input to an alternating current supply suitable for operating the light source of the light assembly 74. The same company can also supply lamps that can be used in the present applications, for example 300 mm long and 3 mm diameter lamps, or other sizes. The alternating current input 76 may take any number of forms and preferably includes a pair of wires equal to or larger than 26 gauge wire, one of which would be a hot lead and the other of which would be neutral. The alternating current input 76 ultimately obtains current from a suitable source such as a supply panel 80 (FIG. 3) in the display case, which provides 115 volts at 60 Hz and the desired amps from a conventional utility source or junction box. The supply panel 80 can and typically does provide current to other components, but the input for the alternating current input 76 is preferably standard 115 volts at 60 Hz and 5, 10, 15 or 20 amps, or 230 volts and 50 Hz in a number of other countries. The amount of current will depend on the number of light sources in the lighting assembly.

The light sources in the lighting assembly are preferably fluorescent light sources, and in particular are preferably cold cathode fluorescent tubes or lamps 82 capable of producing light of at least 5000 K (Kelvin) and preferably 8300 K or more to give a relatively larger percentage of blue than is produced in conventional fluorescent lamps. Relative to conventional hot cathode fluorescent lamps found in most office and industrial applications, cold cathode lamps have significantly lower energy consumption even with greater light output. For example, energy consumption in a cold cathode lamp may be as much as 66 percent less than conventional hot cathode fluorescent lamps while producing as much as 30 percent more light output. Additionally, in many situations where ambient temperature is controlled, such as in office buildings, retail areas such as grocery stores, department stores, and the like, the use of cold cathode lamps will produce additional energy savings during summer time because of a lower air conditioning load used where cold cathode lamps are producing less heat.

Energy savings can also be realized in refrigerated display cases such as those used in grocery stores, convenience stores, and the like. With lower heat being produced in cold cathode lamps, less heat is produced in the lighting assembly inside the refrigerated display case, and less cooling is required for the refrigeration unit in the display case. Consequently, additional savings may be realized by using smaller line sizes and possibly a reduction in compressor horsepower installed in the case.

As an example of some of the energy savings that are possible for a refrigerated five-door display case, standard T-8 lighting and six lamps consuming 70 watts consumes about 420 watts at a present cost of about $290 per year. This assumes about 8 cents per kilowatt-hour. Six vertical sets of lighting assemblies using cold cathode lamps consuming 18 watts uses about 109 watts per year at a cost of about $76 per year. The substitution represents about a 74 percent energy savings.

Additional savings may be derived in the reduction of component costs. For example, sophisticated ballasts used with many fluorescent lighting systems may be replaced by more simple converter circuits such as that described herein. Simplified converter circuits will often have less expensive components and may be easier to manufacture than conventional ballasts. The savings may be particularly beneficial in those applications experiencing extreme conditions such as refrigerated display cases. In refrigerated display cases, conventional fluorescent lamps experience lower bulb wall temperatures, thereby affecting performance. Lower bulb wall temperatures typically lead to strobing, decreased light output, longer starting times, and the like. Ways to reduce these effects typically involve more sophisticated ballasts, higher driving currents and more frequent bulb replacement. The use of cold cathode lamps in refrigerated display cases permits better control of lamp temperatures, and the preferred converter does not use all the same components as are used in many of the ballasts driving conventional fluorescent lamps in refrigerated display cases. Therefore, component costs for the converter may be less.

Component costs may also be reduced by substituting the mounting and connecting hardware of the present inventions for the conventional sockets and other mounting and connecting hardware used with conventional fluorescent lamps.

Cold cathode lamps have longer life times in many situations than fluorescent lamps for the same applications. Additionally, deterioration of a lighting assembly due to frequent maintenance and handling of the lighting hardware will decrease because the lighting assemblies will not need to be handled and accessed as often for maintenance and replacement. Consequently, the overall cost for the light assemblies for maintenance and repair will generally be less than conventional fluorescent lighting systems.

Other savings can be obtained when using cold cathode light assemblies of the present inventions. For example, the lighting assemblies using the cold cathode lamps are not as susceptible to moisture and the cold temperatures when assembled and sealed against the elements as described herein. Such assembly and sealing configurations are made easier by the size of and connection configurations for the cold cathode lamps. Additionally, the amount of wiring for a given amount of light output, for example in a display case, can be significantly reduced both in the amount of wiring and in the size of wires and connecting components.

Moreover, the size and simplicity of the cold cathode lamps make it easier to assemble the lamps in compact and easily manageable lighting assemblies. They can be easily arranged to fit a number of different spacing and orientation configurations for lighting areas as desired. The lamps can be combined and arranged in a number of different configurations to produce lighting assemblies having any number of properties and characteristics. They can be designed to fit into spaces that traditional lighting assemblies will not easily fit, and they can be used to easily retrofit many existing lighting configurations. They also can be easily arranged to optimize the illumination for a given-sized area, whether the area be living or working space or display cases, or other lighting arrangements.

In one preferred form of several aspects of the present inventions, the cold cathode lamp 82 includes an input in the form of an input conductor 84 coupled through an appropriate connector 85 or otherwise to the output 86 of the converter 78 for applying oscillating DC to one end of the cold cathode lamp 82. The other end of the cold cathode lamp includes an output in the form of an output conductor 88 coupled through an appropriate connector 89 or otherwise to a return circuit 90 in the converter 78. The connectors 85 and 89 may take any number of forms, but preferably include a significant surface area of contact and may also include a releasable latch or other engagement portions to provide a reliable electrical circuit between the converter and the lamp.

In one form of the inventions, the connectors 85 and 89 have a large surface area of contact, and are preferably substantially cylindrical pin-type connectors longitudinally and slidingly engaging a cylindrical or split-sleeve connector so that the electrical surface area of contact is at least 25 percent of the length and at least 25 percent of the circumference or perimeter of the pin-type connector and preferably over 50 percent of the length and the perimeter. In one preferred embodiment, the electrical surface area of contact is at least 80 percent of the perimeter and at least 70 percent of the length to reduce as much as possible any impedance to current flow to lamp contributed by the connectors 85 and 89. While longitudinal connector engagement is preferred for its wiping effect and significant surface area of contact, other connector engagement modes are also possible.

The connectors 85 and 89 are also preferably protected both before and after engagement by suitable insulated walls, such as plastic walls. The plastic walls may also be shaped so that only certain relative orientations between the two halves will result in a connection. Additionally, the two halves can include engagement surfaces so that the halves are releasably latched when fully engaged. Molex-brand connectors commonly have these features and can be used for connectors 85 and 89, as well as for other connectors in the assembly.

The cold cathode lamp 82 is preferably sealed in and supported by a preferably acrylic insulating and/or protective envelope or tube 92. The tube 92 preferably thermally insulates the cold cathode lamp from the temperature extremes of the refrigerated display case by providing an air or other gaseous thermal insulating blanket between the tube 92 and outer wall of the cold cathode lamp. The tube 92 also protects the cold cathode tube from impact and other outside physical forces. The tube 92 also serves as a carrier for the lamp, which will help to allow the cold cathode lamp to be handled as a unit along with the tube 92. The tube may a water clear tube or lens and have a wall thickness of about 1/16th of an inch or more, and the outside diameter can be about 3/8, 1/2 or 5/8 of an inch or more depending on the type of protection desired.

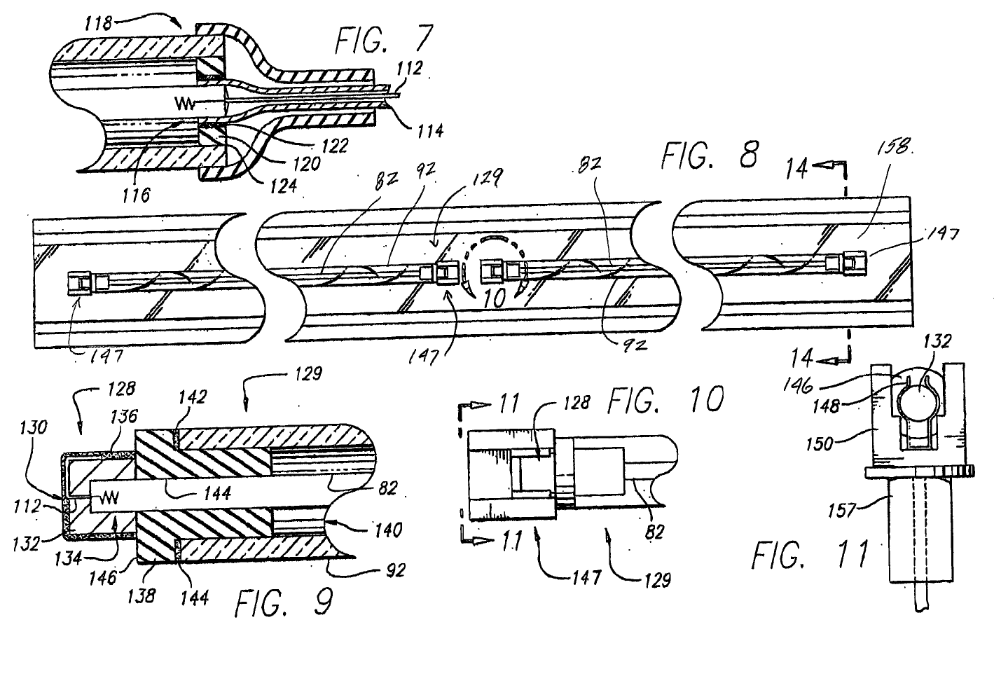

As shown an FIG. 7, an end portion of the cold cathode lamp and the adjacent end portion of the acrylic tube are sealed. Each lamp end is preferably sealed in the same way. The seal preferably helps to maintain an insulating blanket of air or other gas between the cold cathode lamp and the acrylic tube, and reduces the possibility of moisture or other contaminants entering the envelope between the lamp and the tube. In one preferred embodiment, the lamp includes at each end a conductor 112 coupled to the respective lamp electrode extending to the respective connector 85 or 89 within an insulating sheath 114. The insulating sheath 114 preferably extends from the glass envelope of the lamp to the connector. The end portion 116 of the lamp is sealed to the corresponding end portion 118 of the acrylic tube 92 by a neoprene or other suitable seal 120, which may be in the form of an annular seal element. The seal also preferably includes a sealing compound 122 between the insulation 114 or lamp end portion 116 and the seal 120, and sealing compound 124 between the seal 120 and the end portion of the acrylic tube. The sealing compound may be silicone or any other suitable hermetic seal material. The entire terminal portion of the lamp assembly may be covered or protected by a boot 126, which may also serve as a strain relief.

The tube 92, and therefore the cold cathode lamp 82, is supported by one or more lamp supports or engagement clips 94 (FIG. 6) for supporting a given cathode lamp on a support surface 96. The clips 94 may also serve to space the cold cathode lamp from the reflector 66 the desired distance. The engagement clips 94 may take any number of different configurations, but in the embodiment shown in FIG. 6, the clip 94 includes an interference fit cradle 96 formed by a first curved leg 98 and a second curved leg 100 forming a semi-circular seat for receiving a portion of the tube 92. The legs are preferably formed from a suitably strong and resilient material to allow the tube 92 to be inserted into and removed from the clip while otherwise reliably holding the tube in place under normal operating conditions. The material of the clips is preferably plastic but may also be formed from other materials.

The cradle 96 is supported by a post or other structure 104 to space the cradle the desired distance from the support surface 96. In the preferred embodiment, the post 104 includes a supporting base 106 having a bottom surface 108 for contacting the support surface 96. The clip 94 is held in and supported by the base 96 by an insert 110 for extending into and engaging a suitably sized opening in the support surface 96 so as to reliably hold the clip 94 in place. In the preferred embodiment, the insert 110 is formed to have a shape, flexibility and resiliency to allow it to be inserted and removed from the support surface 96, as desired. The support surface 96 can include any number and configuration of openings so that the cold cathode lamps can be positioned and spaced on the support surface in any number of configurations.

In one preferred form of the inventions, the lamp supports are configured so that the lamp is longitudinally movable in at least one of the supports. Allowing longitudinal movement between the lamp and at least one of the supports accommodates differences in dimensions or tolerances in components, as well as allowing flexibility in the positioning of the lamps. The lamp supports are also preferably configured so that the lamp is rotationally movable relative to the supports when the lamps do not have any specific directional characteristics, allowing greater freedom for positioning the lamp. However, if a lens arrangement, reflector arrangement or some other optic design characteristic is incorporated in the lamp and tube assembly, that makes directional characteristics significant, it may be preferred to keep the lamp assemblies rotationally fixed.

The lamps can be positioned in any number of ways, to achieve the desired illumination. For example, lamps can be arranged in a linearly staggered configuration, such as that shown in FIG. 4, or they may be aligned linearly as shown in FIG. 8. A linearly staggered configuration or overlapping lamps can be used to increase illumination of defined areas or reduce the possibility of visible lines created by the end effects of adjacent lamps. However, discontinuities in lamp positioning may affect the use of optic elements such as reflectors and lenses. Laterally offset lamps can be used with flat reflectors and used with lens arrangements which are also supported by the clips 94, without significantly affecting the light distribution. However, with other optic configurations having fewer degrees of freedom, it may be preferable to design the clips 94 to restrict the rotational and/or longitudinal movement of one or more of the lamps, as well as where the lamps can be placed.

The lamp supports can also position the lamps at any desired height from the base or carrier, depending on space limitations, and on any optic limitations that may be incorporated into the design. For example, light distribution using a flat reflector without a lens is not affected as much by lamp height as it would be when using a shaped reflector and/or a lens. In the embodiment shown in FIG. 5, the lamp assembly is preferably placed as close as possible to the reflector 66, which in turn places the central axis of the lamp several millimeters from the surface of the reflector 66.

The clips 94 can be configured to mechanically hold the lamp assembly so that the lamp is not normally removable without manually releasing the lamp assembly from the clips. For example, one or more of the clips supporting a lamp can include the arm or other latching portion for extending over the tube from one side of the clip to releasably engage the other side of the clip. Alternatively, the two arms of the clip can pivot open and closed with respect to each other and can be locked at the other ends about the tube. As a further alternative, each clip can be secured about the circumference of the tube 92 and the lamp assembly can be removable by removing the clips from the support surface 96.

The other significant function of the clips, supporting the lamp assemblies relative to the support surface 96, can also be achieved in a number of ways. The clips may include a latch or other engagement, which can be manipulated to release the clip from the support surface. Alternatively, each clip can include engagement surfaces, which can appropriately inter-lock with complementary surfaces in the support surface. The clips then remain in place until manually removed or released.

In the preferred embodiment, the lamp and clips are positioned relative to reach other preferably to minimize any blocking of light from the lamp by the clips. For example, the clips 94 are placed adjacent or at the end portions of the lamps. The clips can also engage the insulation or other material on the ends of the acrylic tubes 92.

The electrical connection between the electrodes of the lamp and the connectors 85 and 89, respectively, can take different forms as well. In the embodiment shown in FIGS. 4 and 5, the wire 112 can be crimped or otherwise conductively connected to an appropriate connector element (not shown) such as a pin connector, blade connector, or the like. Suitable insulation such as the insulating sheath 114 preferably covers and insulates the crimped junction. Other configurations exist for making the electrical connection between the lamp and none connectors 85 and 89.

In one preferred form of the inventions, an electrical contact 128 is formed on an end portion of the lamp 82 (FIG. 8) in the lamp assembly 129. In this embodiment, the wire 112 is threaded through an opening 130 in a sleeve or cap 132 over the end 134 of the lamp 82. The wire 112 is then extended radially outwardly over the end surface of the cap 132 and longitudinally back along an outer circumferential surface of the cap 132. The wire 112 may then be electrically engaged with a suitable connector for supplying current to the lamp. Where the wire is the principal conduit for supplying current from the connector to the lamp, the cap 132 may be an insulating cap. However, in the preferred embodiments, the cap 132 is preferably a conductive cap placed over the end of the lamp and the wire 112 and soldered to it, so that the cap then becomes an electrically conductive connector or contact for the lamp. The solder is shown at 136. The size of the cap 132 as shown in FIG. 8 is enlarged for illustration purposes, and is preferably smaller with thinner walls. Other configurations of the connection between the wire 112 and a conductive cap to form a lamp contact can also be provided in other ways, for example placing wire 112 between a small insulating cap over the lamp end and an outer conductive cap over the insulating cap. Alternatively, the wire 112 end may make contact with the cap at other points on the cap, such as through an opening in the circumferential surface of the cap, in grooves formed in the cap, or in other ways.

The lamp 82 may be sealed within the end of the acrylic tube 92 by a neoprene, silicone or other flexible and resilient plug 138 extending into the bore 140 of the tube 92 and outwardly over the end surfaces of the tube 92. The plug 138 is preferably split and placed over the lamp and resealed. The plug 138 and the tube 192 are preferably sealed against air and moisture by a suitable sealing compound such as silicone or another hermetically sealing compound represented at 142, and the plug 138 and lamp 82 are preferably sealed against air and moisture by the same or a similar sealing compound represented at 144. A seal may also be formed, if desired, between the axially-facing surface 146 and the adjacent surface of the cap 132. Each lamp and each end of each lamp is generally preferably configured to be the same, and may have the structure represented in FIG. 8.

Other configurations for the end of each lamp may be used. For example, the exposed end of the plug 138 may extend axially along the cap 132 leaving an annular gap between the circumferential surface of the cap 132 and the inside surface of the plug 138. The annular gap may then accept and protect a contact element for making electrical contact with the cap 132 and supplying current to the lamp. Additionally, the cap 132 may be other than circular in cross-section and may include surfaces specifically configured to make electrical contact with the opposite contact element. In one preferred embodiment, contact is achieved by placing the opposite contact element in the form of a complementary-shaped cylindrical sleeve or closed-ended cap longitudinally or axially over the cap 132. In another embodiment, contact is achieved by moving the lamp laterally so that the circumferential surface of the cap 132 engages one or more surfaces on a U-shaped receptacle, or a receptacle having another shape suitable for making electrical contact with a portion of the circumferential surface of the cap 132. Electrical contact can also be achieved by contacting the end face of the cap 132.

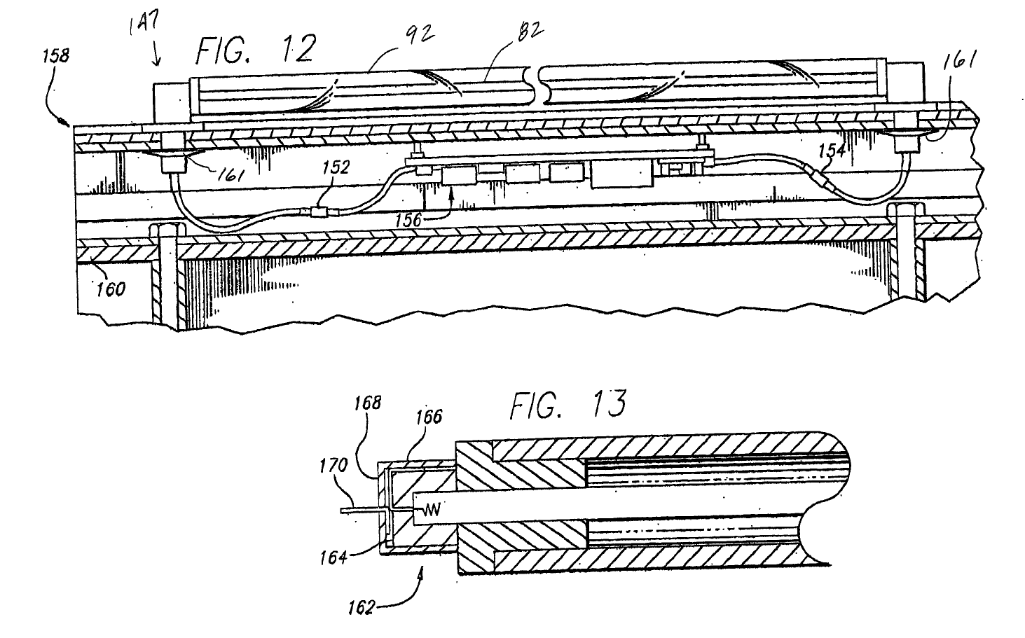

As an example of the circumferential contact configuration, a lamp carrier and contact combination in the form of a trough- or U-shaped socket 147 (FIGS. 10 and 11) laterally receives and makes electrical contact with the lamp 82 through the contact 128. The lamp 82 is preferably part of a lamp assembly 129 such as that described with respect to FIG. 8. The socket 147 includes a curved contact 148 having a U-shape, horse shoe-shape or other appropriate shape for maximizing the electrical surface area of contact with the cap 132. The contact 148 is coupled to a connector such as connectors 152 or 154 or may be directly coupled to the converter 156, identical to or similar to converter 78, for supplying current to or receiving current from the lamp. A plastic or other preferably insulating housing or carrier 150 protects and supports the curved contact 148. The housing 150 is mounted to or supported through a bushing 157 by a lamp carrier 158 (FIG. 12), which in turn is mounted to or supported by part of the display case, such as the mullion 160. The bushing may be held in place by a tenement washer, lock washer, fastener or other mounting, attachment or holding means 161.

The contact 148 is preferably configured to provide as much surface area of contact as possible while still permitting the easy installation and removal of the lamp. In one preferred embodiment, the contact 148 makes contact with the lamp contact 128 over at least 180 degrees of the circumference of contact 128, and preferably more. It is preferred that the lamp be contacted over at least 25 percent and preferably more than 50 percent of the available contact surface area to insure good electrical connection and to reduce the possibility of significant impedance in the connection between the lamp and the contact 148. Whether the angle of contact between 128 and 148 can approach or exceed 270 degrees will depend on the strength and resilience of the material of contact 148.

The connectors 152 and 154 are preferably configured to also have longitudinal connections with high surface areas of contact and with protective insulating walls around the connection. They can also have engagement surfaces for mating opposite connector portions and latches or other releasable mechanisms for holding the portions together during normal operation conditions.

In a further form of a contact for engaging the lamp contact 128, a substantially cylindrical contact 162 (FIG. 13) extends substantially around a circumference of the lamp contact 128, and, in the preferred embodiment, also at least partly contacts the end face 164 of the lamp contact. The contact 162 preferably has an inside diameter approximately equal to or slightly smaller than the outside diameter of the lamp contact 128 to ensure a good contact between the two. The cylindrical wall 166 to the contact 162 may be longitudinally split so that the wall is somewhat flexible and reliably engages the lamp contact wall as the contact 162 is placed longitudinally over the lamp contact. The cylindrical wall 166 preferably makes electrical contact over at least 50 percent of the length of the lamp contact 128, to increase the surface area of contact. The end face 168 of the contact 162 also preferably makes electrical contact, but such contact may be minimal. A conductor 170 may extend through an opening in the end face 168 or may be crimped, soldered or otherwise coupled to the end face 168. The contact 162 may be used with the lamp assemblies shown in FIG. 5, supported by the clips 94. The contact 162 may also include a plastic or other insulated housing covering the outside of the contact 162. The plastic is preferably able to withstand high voltages, for example as high as 800 or 1000 volts.

One preferred lamp assembly of the lamp 82, tube 92, sealed ends along with the input for the lamp and the output of the lamp can be mounted or supported in a number of ways. In one preferred embodiment, the lamp assembly is mounted on a carrier so that the lamp assembly can be moved, mounted, serviced and replaced, if desired, as a unit or a module. While individual lamps can be installed, serviced or replaced individually, it may also be desirable to install, service or replace the lamp assemblies as part of a unit or module of lamp assemblies. For example, one or more lamp assemblies can be mounted to the carrier 158 on a support plate 172 mounted, carried or supported by a base 174, which in turn is mounted, supported or formed integral with a mullion 176, or another portion of the frame, display case or other structure. The base 174 may be formed of a metal or plastic channel and fastened to a mullion wall 178 through a mullion cover 180 by a fastener 182 passing through and anchored through an insulating sleeve 184. The mullion wall 178 is typically a metal frame member insulated by the plastic mullion cover 180 from the cold environment of the refrigerated display case. The base 174 typically extends the entire length of the mullion 176. The mullion shown in FIG. 14 is a center mullion, but it should be understood that the base 174 can be mounted to an end mullion, an upper or lower frame element, a wall or other surface of the case, a shelf or any other surface from which the light assembly can be supported.

The base 174 may be formed as a rectangular channel with side walls 186 and 188 extending away from the surface of the mullion for supporting respective engagement surfaces 190 and 192 on the carrier 158. The carrier 158 may have a number of configurations, the one shown in FIG. 14 having the overall shape of a rectangular channel extending longitudinally substantially the length of the mullion to illuminate the full height of the display case. The carrier 158 may be supported by the base 174 through fasteners (not shown), hooks, latches, clips, zipper strips or other engagement surfaces that will reliably hold the carrier 158 on the base 174 under normal operating conditions. In the preferred embodiment, the carrier can be relatively easily removed for servicing and re-installation or replacement.

The carrier 158 is preferably designed to include sufficient space for conductors 194, which may include the input and output conductors for the lamps, as well as for the connectors 85 and 89 and the converters 156. The converters 156 are preferably mounted within the channel and spaced sufficiently apart from each other and spaced sufficiently from the surface of the carrier to reduce any electrical interference or other effects. For the same reason, the carrier 158 may be formed from a suitable plastic or low conductivity metal.

In the embodiment shown in FIG. 14, the lamps are supported by and electrically coupled to connectors 147, which in turn are mounted to and supported by the transverse wall 196 of the carrier 158. The lamps can be fixed to carrier 158 or removably mounted to the carrier, as desired. Various mounting arrangements can be used to achieve the desired structure and function.

The carrier 158 can also support a reflector or other optic surface 198 for distributing light from the lamp assemblies as desired. The reflector can be placed against the transverse wall 196 and under flanges 200 and 202. In the embodiment shown in FIG. 14, the reflector 198 is a flat metal reflector extending substantially the width of the carrier 158 and the length of the carrier at least to the extent of the overall combined length of the lamp assemblies. The reflector can be formed from other materials as well. The reflector 198 can distribute light shining from the back half of the lamp assemblies forwardly toward the shelves and the product on the shelves. The reflector 198 can be parabolic, symmetrical about a longitudinal center line, elliptical or any other shape to produce the desired light distribution. Additionally, the reflector 198 can be formed integral with the carrier, or may have multiple components, each producing their own effect on the light distribution. One or more of the components can be integral with the carrier and others can be separate. The reflector can be formed as a polished surface, mirror-like, a foil, reflective paint or other coatings, or prisms or other optic surfaces that can be used to disperse or redistribute light in the direction of the shelves, or to produce any other desired effect.

A lighting assembly comprised of the lamp assembly and the carrier 158 preferably includes a connector for connecting the lighting assembly to a source of energy or current. The connector can take a number of forms, and can be a receptacle in the form of a socket or receiving element or the connector can be a plug or similar connection element for mating with a complementary connector on the support surface. In one preferred embodiment, the carrier 158 includes a connector 204 (FIG. 14) mounted to or otherwise supported by the carrier for receiving current from a suitable energy source. The connector 204 is electrically coupled to one or more of the converters 156 either directly or through a bus or junction arrangement to allow supplying energy to more than one converter at the same time. The connector 204 is preferably fixedly mounted or otherwise reliably supported by the carrier 158 and preferably off center or off any axis of symmetry of the carrier 158 and the base 174 to ensure proper orientation of the carrier 158 relative to the base 174 before the connector 204 connects with the mating connector 206. The connectors 204 and 206 are preferably mounted so that the connector 204 is close to the converter 156 or approximately centered between multiple converters 156 so the conductor 208 from the connector 204 is relatively short. The connectors 204 and 206 can also be positioned at other locations on the carrier 158 and the base according to the desired configuration. The connectors 204 and 206 can also be placed loose within the carrier 158 or even outside the carrier, such as outside the plastic cover 180, between the plastic cover 180 and the mullion 178 or within the enclosure defined by the mullion 178. The connector 206 is preferably mounted through the base 174 to the mullion cover 180 and includes appropriate conductors 210 coming from an appropriate bus, junction or other current supply in the display case.

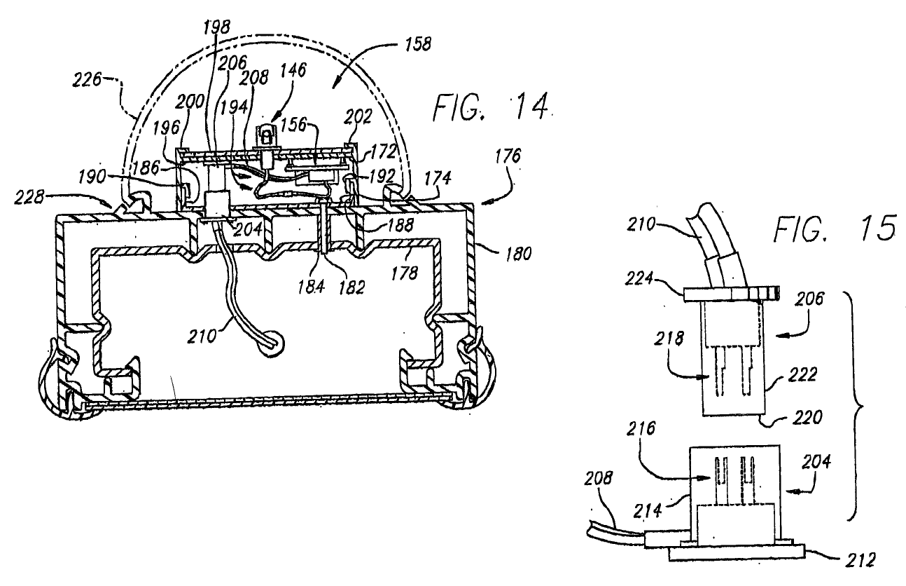

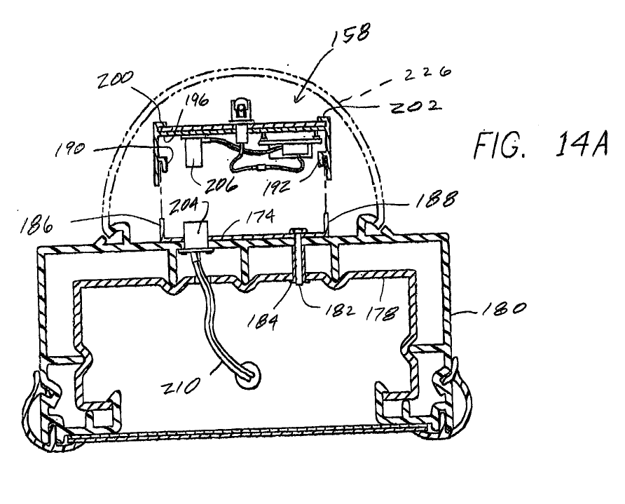

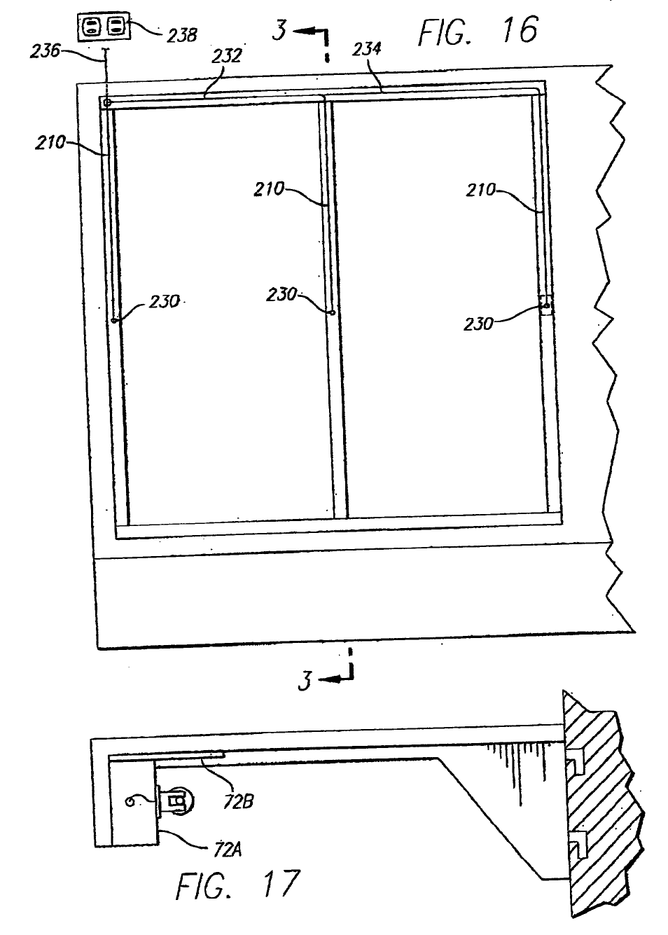

In one preferred embodiment, the connector 204 includes a mounting plate 212 (FIG. 15) and a protective insulating wall 214 around a pair of cylindrical or slotted receiving connectors 216 for mating with a corresponding pair of cylindrical pin connectors or flat blade connectors 218. The connectors 218 are recessed below the rim 220 of a protective cylindrical wall 222, which terminates at a mounting plate 224. While other connector arrangements are possible, the connectors 204 and 206 preferably provide a high surface area of contact and include insulating walls protecting the connection between the two components.

The connector combination of 204 and 206 contribute to the design and use of the light assembly as a unit or modular construction. Having a connector between the converter or converters 156 and the base or other support surface makes it easier to design the light assembly and the support configuration so the light assembly can be shipped, installed, serviced, removed or replaced as a unit or plurality of units (the removal and replacement process being depicted in FIG. 14A). The light assemblies can be smaller while still providing improved light output, color, efficiency and cost.

The light assemblies can be protected by one or more shields 226 covering or extending over the light assemblies. Each shield 226 is preferably mounted to or supported by engagement portions 228 on each side of the carrier 158. The shield may be a clear plastic, acrylic or other structural device to protect the lamp assembly or the entire light assembly from impact, such as from product being removed from the display case, during stocking or the like. In the preferred embodiment, the enclosure defined by the shield 226 is sealed from the outside environment such as by sealed edges, foam or otherwise.

In a further form of the inventions, one or more lenses may be mounted adjacent the lamp assemblies, and may form part of the light assemblies that can be installed, serviced and replaced as a unit or complete module. For example, lenses can be mounted to the carrier 158 on each side of the lamp assemblies to have a configuration similar to the assemblies shown in U.S. Pat. No. 5,895,111, incorporated herein by reference.

The lamp assemblies and light assemblies can be positioned in a number of different locations, orientations and configurations, including the vertical, longitudinally extending arrangements on end and center mullions represented in FIGS. 2-4 and C-E, as well as the horizontally extending arrangements on frame members represented in FIG. 3 and on shelves also shown in FIG. 3. The lamp assemblies and light assemblies can also be mounted elsewhere in display cases and other areas for illumination. The lamps can be aligned linearly or offset, with or without overlap, at identical or different distances from a reference point, such as a reflector, and they can be different shapes, orientations and sizes.

The conductors 210 enter the mullions through respective openings 230 and extend upwardly or downwardly to a horizontal frame member, such as an upper horizontal frame member 232 in the drawing. Each conductor 210 is coupled through an appropriate connector to a bus wire assembly 234 extending across the horizontal frame member 232. The bus wire assembly 234 is supplied by a supply wire assembly 236 receiving current from a socket, junction box or other utility panel 238. Other wiring configurations can be used.

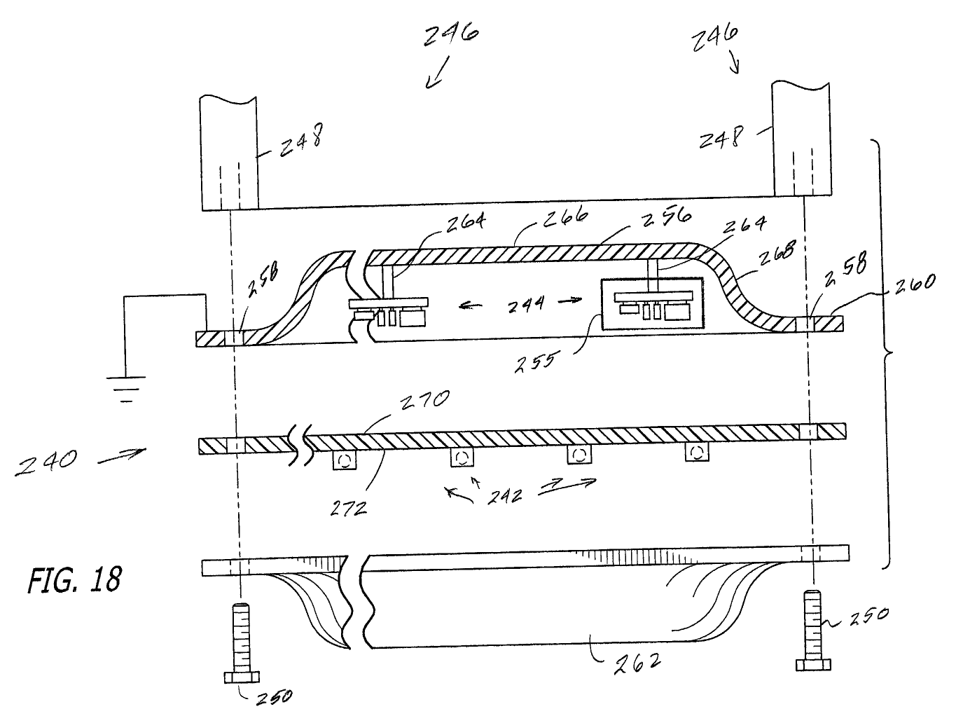

In accordance with another aspect of one of the present inventions, a lighting system 240 (FIG. 18) having cold cathode lamp assemblies 242, such as those described previously, and converters 244 can be used to provide lighting for buildings, offices, meeting rooms and workspace and for other applications for which hot cathode fluorescent lamps are currently used. In one form of the inventions, the lighting system can be used to retrofit existing fluorescent lamp fixture installations or in new structures where fluorescent lighting fixtures would have been used. The number of lengths, diameters and shapes of cold cathode lamps available make substitution for existing fluorescent lamp fixtures straightforward. In the embodiment shown in FIG. 18, the lighting assembly is configured to replace an existing fluorescent lighting fixture in a ceiling structure 246. The ceiling structure 246 can take any number of forms, such as a suspended ceiling or otherwise. The ceiling structure 246 is shown schematically as a plurality of support elements 248 for receiving respective fasteners or other mounting elements 250. However, the ceiling structure and the mounting elements can take any number of configurations now known or hereafter developed to accommodate the configuration of the lighting system.

The converters 244 may be inverters of the type previously described from Visualux and are preferably configured to receive an AC input over an input circuit 252 (FIG. 20) from a socket, junction box or utility panel such as 238 described above. The AC input could be at 15 volts or 220 volts at the desired amperage and could be connected to the building electrical wiring through suitable connectors 254. The converters can also be inverters of other designs. Another suitable inverter is the model number I-12JJJ480J inverter from Tachai Industrial Company of Taipei Taiwan which is preferably used with their cold cathode lamp model number CCFL26420. Each inverter is preferably wrapped, surrounded or enclosed by fish paper or vulcanized fiber 255. That lamp is a 2.6 mm diameter, 420 mm long lamp having a nominal input voltage of about 14 volts DC and a nominal input current of about 403 mA DC, with a reference lamp voltage of about 886 volts rms and lamp current of about 5.0 plus or minus 1.0 mArms. That lamp has luminous wave lengths in the red region of about 611 nm, green about 544 nm and blue about 440 nm. It has a neon and Argon fill gas within a glass envelope or tube. Other lamps may be suitable and can be substituted as desired, the selection of which may depend on size, shape, color, lifetime and other factors. Other inverters may be suitable as well. A brass or other metal sleeve (not shown) can be used, if desired, to increase the effective outer diameter of each end of the lamp to make adequate contact with the cap 132 or any other device used to insure adequate electrical contact between the wire 112 (FIG. 9) and a contact 148 in a connector or receptacle, described more fully below. The sleeve can be any length desired and may extend within the plug 138.

In the embodiment shown in FIG. 18, the converters 244 are preferably mounted to and supported by a housing 256. The housing can be configured to be mountable into a ceiling cavity, opening or other suitable location, for illuminating an area, or it may be configured to illuminate an area from a wall or other desired support. In the embodiment discussed herein, the housing 256 is mountable to the supports 248 through the fasteners 250 passing through openings or holes 258 formed in a relatively planar rim 260, preferably extending completely around the perimeter of the housing. The housing 256 can be conveniently formed from a conventional diffuser for fluorescent lighting fixtures, and an identical diffuser 262 may be removably mounted in the ceiling in a conventional way. The use of a conventional diffuser for the housing 256 would be especially appropriate for retrofitting existing lighting fixtures as the dimensions are already established. Additionally, such diffusers are typically made from non-conductive materials such as plastics, which materials would also be suitable for housing the lighting system. Each inverter and its surrounding fish paper 255 is mounted to and supported by the housing 256 through one or more standoffs 264 fastened, bonded or otherwise preferably fixed to the housing at an approximately planar portion 266. The planar portion 266 extends outwardly to side walls 268, which flatten out to the planar rim 260. The input conductors 252 (FIG. 20) can enter the housing through an appropriate opening (not shown) at any desired location to allow coupling to the electrical wiring from the building. It should be noted that the mounting of the lighting system is shown generically with fasteners, but it should be understood that the mounting can be done using conventional construction, including hidden latches, relief walls, and the like.

The lighting system also preferably includes a mounting arrangement for the cold cathode lamps 242. In the embodiment shown in FIG. 18, the lamp mounting element takes the form of a panel 270, preferably formed from a suitable nonconductive material such as plastic and which preferably has a low magnetic permeability, and extends across the entire open surface area of the housing 256 so that the electronics, including the inverters and any wiring into and out of the inverters, are covered by the panel 270. The panel 270 can be sized so as to be sandwiched between the housing 256 and the diffuser 262, or it can be smaller so as to fit within the recess defined by the curved side walls 268. The panel can be held in place by clips, adhesive, tape, fasteners or any other suitable means. The lamps can be arranged in any configuration desired on the panel, in any number, shape and characteristic. Additionally, the panel need not be flat and can take any number of different shapes and configurations, for example depending on the lighting effect desired for the surrounding area.

The panel 270 is preferably opaque to light and prevents any light from the cold cathode lamps 242 from passing through the panel. The lamp-facing surface 272 of the panel is preferably reflective in the same manner as the reflector 198, as described above, and a may have an uneven white surface (not shown) so as to diffusely reflect light from the cold cathode lamps.

The diffuser 262 can be any conventional light cover, may be clear, partially translucent, incorporate optical properties such as prisms, lens elements, Fresnel surfaces, and the like. The diffuser 262 can take any number of shapes, dimensions and appearances as do conventional diffusers, as well as any configurations developed hereafter. For the lighting system of the present inventions, a diffuser can also be omitted or substituted by a clear cover.

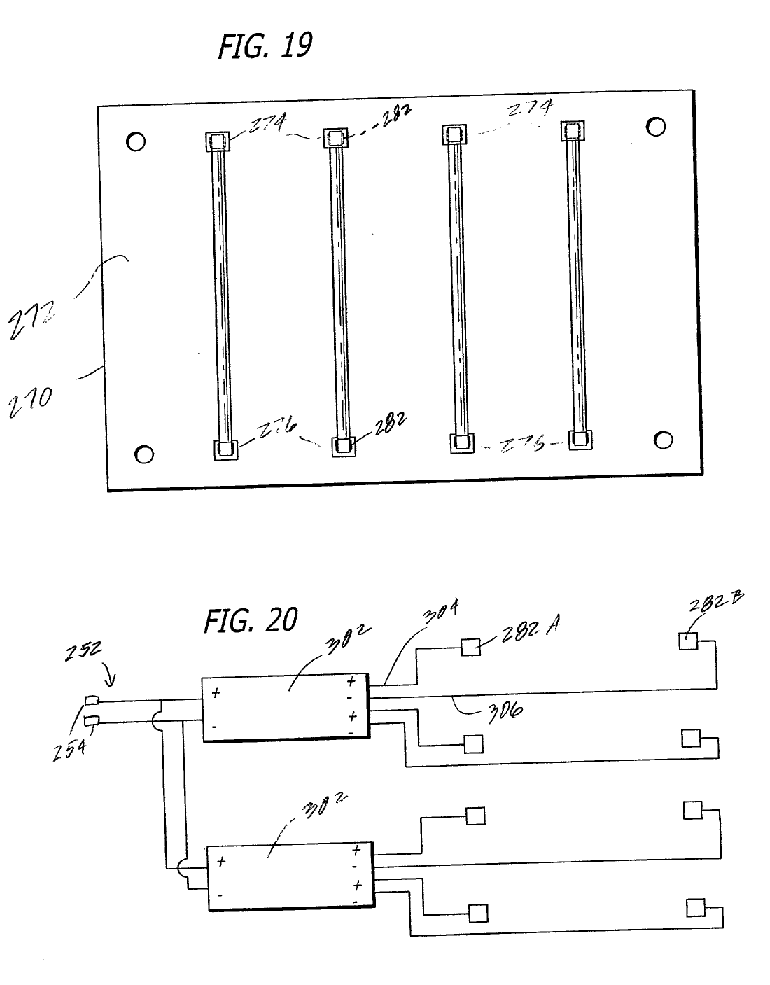

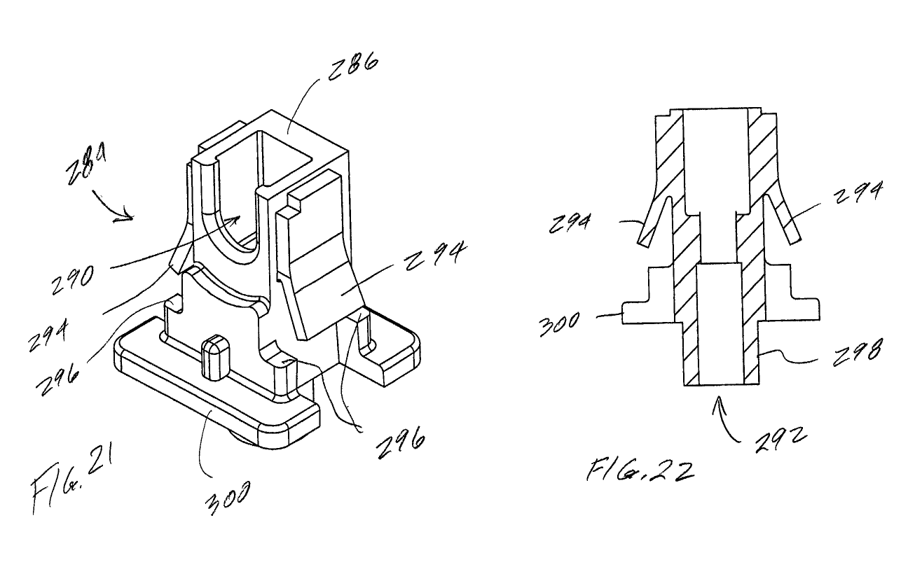

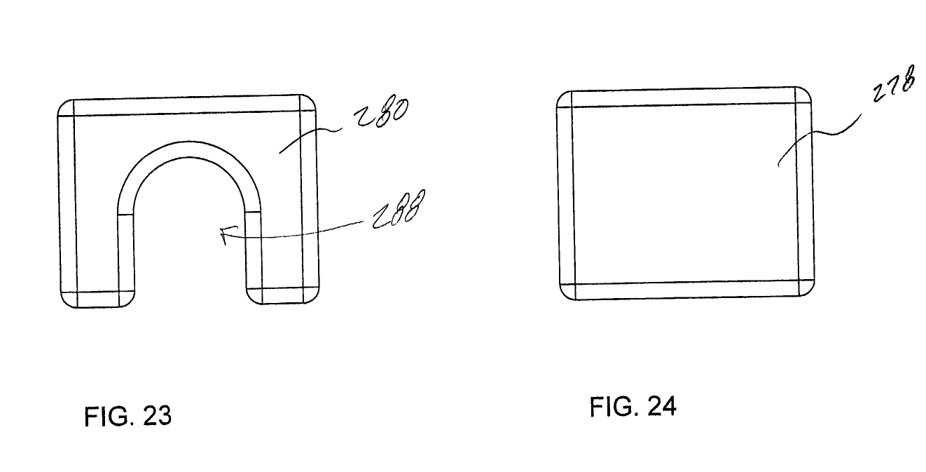

Each cold cathode lamp is preferably supported on the panel 270 and electrically coupled to the drive circuit through first and second receptacles 274 and 276, respectively (FIG. 19). The receptacles can be identical to those described above, but in this preferred embodiment, the first receptacles 274 have a closed top such as top 278 (FIG. 24) and a side opening, and the second receptacles 276 have an open top such as top 280 (FIG. 23) as well as a side opening. The first receptacles are preferably closed on top so as to reduce the possibility of a person touching any electrically conductive surfaces at the lamp connection or the contacts, such as those at 282, within the receptacle when a lamp is removed. As will be described below, the high voltage supply is preferably coupled to the contacts in the first receptacles. Otherwise, the receptacles are preferably identical, and may take the configuration such as the monument-style receptacle 284 shown in FIG. 21. One or the other of the tops 278 and 280 are placed over the top 286 of the receptacle 284. The open top 280 allows the second end of cold cathode to be inserted vertically along a vertical axis from the top of the receptacle through the opening 288 (FIG. 23) in the top. The first end of the cold cathode is inserted first into the first receptacle through the side opening 290 and under the top 278 (FIG. 24). The electrically conductive surfaces on the ends of the cold cathode lamp will then make contact with respective contacts (not shown) extending within the bore 292 (FIG. 22) of each receptacle. Each receptacle preferably includes resilient and flexible wings 294 for engaging the lamp side surface 272 of the support panel 270. The shoulders 296 engage the opposite side of the panel 270 to hold the receptacle in place. A wall 298 (FIG. 22) preferably extends below the base 300 to provide a relief for the conductor from the inverter coupled to the contact in the bore of the receptacle.

For a four lamp arrangement such as that shown in FIG. 19, two inverters 302 (FIG. 20) can be used to drive the four lamps, two lamps per inverter. Each inverter takes the conventional AC input, such as from the building electrical wiring, junction box or the like, and provides a high voltage output 304 to a separate connector inline between the inverter and the first receptacle 274 or directly to the contact 282A in the receptacle, shown schematically in FIG. 20. The return or neutral 306 is likewise connected to the contact 282B in the second receptacle. Preferably, the wire length for the high voltage output 304 is no more than 200 mm and the wire length for the neutral return circuit 306 is no more than 400 mm. Also preferably, each inverter is capable of producing 15 volts DC and 400 mA DC and an operating current of 6 mArms at 900 Vrms.

Having thus described several exemplary implementations of the invention, it will be apparent that various alterations and modifications can be made without departing from the inventions or the concepts discussed herein. Such operations and modifications, though not expressly described above, are nonetheless intended and implied to be within the spirit and scope of the inventions. Accordingly, the foregoing description is intended to be illustrative only.

What is claimed is:

1. A lighting system comprising:
an input circuit having an AC input from a line voltage supply;
a cold cathode lamp having an input and an output; and
a converter coupled between the input circuit and the cold cathode input for converting the AC input from ordinary line voltage to a voltage and current for operating the cold cathode lamp.

2. The lighting system of claim 1 wherein the input circuit includes connectors for connecting to electrical wiring in a building.

3. The lighting system of claim 2 wherein the input circuit includes converter connectors for connecting to the converter.

4. The lighting system of claim 1 wherein the cold cathode lamp includes a glass envelope containing a gas mixture including neon and Argon.

5. The lighting system of claim 4 wherein the glass envelope is less than 3 mm in diameter.

6. The lighting system of claim 4 wherein the cold cathode lamp is approximately 1 foot in length.

7. The lighting system of claim 4 wherein the cold cathode lamp is approximately 480 mm in length.

8. The lighting system of claim 1 wherein the converter is configured to power two lamps.

9. The lighting system of claim 8 wherein the converter includes an input coupled to the input circuit and two output circuits coupled to respective lamps, and wherein the converter further includes two return circuits from respective lamps and wherein each of the two output circuits are shorter in length than the corresponding return circuits from the respective lamps.

10. The lighting system of claim 1 further comprising a housing for mounting in one of a wall and a ceiling and wherein the converter is supported by the housing.

11. The lighting system of claim 10 wherein the housing is plastic.

12. The lighting system of claim 1 further comprising a housing for mounting in one of a wall and a ceiling and a lamp mounting element supported by the housing for mounting the cold cathode lamp.

13. The lighting system of claim 12 wherein the lamp mounting element includes a panel extending across at least part of the housing.

14. The lighting system of claim 12 wherein the lamp mounting element includes a surface facing the lamp for reducing the amount of light from the lamp that passes through the lamp mounting element.

15. The lighting system of claim 14 wherein lamp mounting element surface prevents all light from passing through the lamp mounting element.

16. The lighting system of claim 15 wherein the lamp mounting element surface is white.

17. The lighting system of claim 14 wherein the surface of the lamp mounting element is uneven.

18. The lighting system of claim 1 further comprising a first lamp receptacle for the lamp input and a second lamp receptacle for the lamp output wherein the first and second lamp receptacles are different from each other.

19. The lighting system of claim 18 wherein the first lamp receptacle includes a cover for covering the lamp input when the lamp input is positioned in the first lamp receptacle.

20. The lighting system of claim 19 wherein the first lamp receptacle is coupled to a positive output of the converter.

21. The lighting system of claim 19 wherein the second lamp receptacle includes a base and a wall defining an opening facing at least partly away from the base and sized to receive the lamp output.

22. The lighting system of claim 1 further comprising a cover extending at least partly over the lamp.

23. The lighting system of claim 22 wherein the cover is formed from a material for transmitting light.

24. The lighting system of claim 1 further comprising a housing for supporting the converter and a lamp support supported by the housing for supporting the lamp and a cover for covering the lamp.

25. The lighting system of claim 24 wherein the housing and the cover enclose the lamp.

26. The lighting system of claim 25 wherein the lamp support is a panel sandwiched between the housing and the cover.

27. The lighting system of claim 26 further comprising first and second lamp receptacles mounted to the lamp support and wherein the converter is mounted to the housing.

28. The lighting system of claim 27 further comprising a plurality of lamps supported by the panel so that the lamps are between the panel and the cover.

29. The lighting system of claim 28 wherein each of the plurality of lamps includes first and second ends wherein the first lamp end is coupled to and supported by a first lamp receptacle having a closed top and the second lamp and is coupled to and supported by a second lamp receptacle having an open top.

30. A lighting system for a building, the lighting system comprising:
a housing for being supported by a structure in the building;
a cold cathode lamp having a first contact and a second contact and being supported by the housing;
an inverter having a first output electrically coupled to the first contact of the cold cathode lamp and a second output electrically coupled to the second contact of the cold cathode lamp; and
a first receptacle for receiving the first contact of the cold cathode lamp and a second receptacle for receiving the second contact of the cold cathode lamp wherein the first receptacle has a closed top and an open side and wherein the second receptacle has an open top.

31. The lighting system of 30 wherein the housing includes a base and wherein the inverter is supported by the base.

32. The lighting system of 30 further comprising a cover extending over the housing and supported by the housing for extending over the cold cathode lamp.

33. The lighting system of 30 wherein the inverter is capable of producing 15 volts DC and 400 mA DC and an operating current of 6 mArms at 900 Vrms.

34. The lighting system of 30 further comprising a panel supported by the housing wherein the first and second receptacles are mounted to the panel and wherein the inverter is mounted to the housing and electrically coupled to the first and second receptacles through wires.

35. A lighting system for a building, the lighting system comprising:
a housing having a base and at least one wall;
a panel supported by the housing;
first and second receptacles mounted to the panel for receiving respective ends of a lamp;
a cold cathode lamp having a first end supported by the first receptacle and a second end supported by the second receptacle; and
an inverter mounted to the base of the housing and having a first output electrically coupled to the first end of the cold cathode lamp and having a second output electrically coupled to the second end of the cold cathode lamp and having an input circuit coupled to the line electrical supply for the building.
